(19) United States
(12) Patent Application Publication
(10) Pub. No.: US 2016/0315509 A1
(43) Pub. Date: Oct. 27, 2016

(54) Electric Machine for a Vehicle

(71) Applicant: Ford Global Technologies, LLC, Dearborn, MI (US)

(72) Inventor: Rihong MO, Ann Arbor, MI (US)

(21) Appl. No.: 14/696,812

(22) Filed: Apr. 27, 2015

(51) Int. Cl. H02K 1/16

(52) U.S. Cl. CPC H02K 1/165

(57) ABSTRACT

An electric machine for a vehicle includes a rotor and a plurality of laminations stacked to form a stator core. Each of the laminations has teeth extending towards the rotor and defining slots. The stator core includes first and second sets of laminations. The teeth of the first set are narrower than the teeth of the second set. The electric machine also includes windings wound in the slots to form coils.

### TECHNICAL FIELD

The present disclosure relates to stator designs for an electric machine capable of acting either as a motor or as a generator.

### BACKGROUND

Vehicles such as battery-electric vehicles and hybrid-electric vehicles contain a traction-battery assembly to act as an energy source for the vehicle. The traction battery may include components and systems to assist in managing vehicle performance and operations. The traction battery may also include high voltage components, and an air or liquid thermal-management system to control the temperature of the battery. The traction batteries are electrically connected to an electric machine that provides torque to driven wheels. Electric machines typically include a stator and a rotor that cooperate to convert electrical energy into mechanical motion or vice versa.

### SUMMARY

According to one embodiment, an electric machine for a vehicle includes a rotor and a plurality of laminations stacked to form a stator core. Each of the laminations has teeth extending towards the rotor and defining slots. The stator core includes first and second sets of laminations. The teeth of the first set are narrower than the teeth of the second set. The electric machine also includes windings wound in the slots to form coils.

According to another embodiment, an electric machine includes a rotor and a stator core. The stator core includes a middle region having first laminations with teeth extending towards the rotor and defining slots, and an end region having second laminations with teeth extending towards the rotor and defining slots. The teeth of the second laminations are narrower than the teeth of the first laminations creating wider slots in the second laminations than in the first laminations. The electric machine also includes windings wound in the slots to form coils.

According to yet another embodiment, an electric machine stator includes an inboard set of laminations stacked to define a middle portion of the stator, and including first teeth that define slots. The stator also includes an outboard set of laminations stacked to define an end portion of the stator, and including second teeth defining slots. The second teeth have a circular width that is less than the first teeth so as to provide wider slots in the outboard set than in the inboard set.

### BRIEF DESCRIPTION OF THE DRAWINGS

FIG. 1 is a schematic diagram of an example hybrid vehicle.

FIG. 2 is a perspective view of a stator core.

FIG. 3 is a perspective view of a stator having the stator core of FIG. 2.

FIG. 4 is a fragmented top view of the stator core of FIG. 2.

FIG. 5 is a top view of a lamination of an end region of the stator core.

FIG. 6 is a top view of a lamination of a middle region of the stator core.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

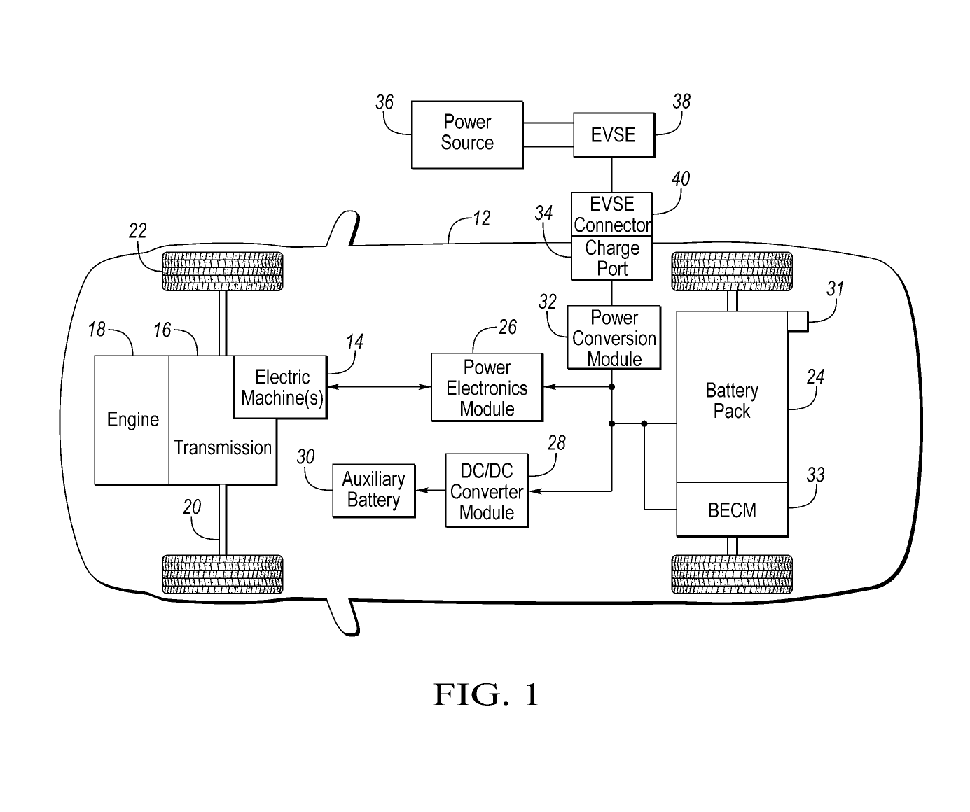

FIG. 1 depicts a schematic of a typical plug-in hybrid-electric vehicle (PHEV). Certain embodiments, however, may also be implemented within the context of non-plug-in hybrids and fully-electric vehicles. The vehicle 12 includes one or more electric machines 14 mechanically connected to a hybrid transmission 16 and electrically connected to the traction-battery assembly 24. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned on or off The electric machines 14 also act as generators and can provide fuel economy benefits by recovering energy through regenerative braking The electric machines 14 reduce pollutant emissions and increase fuel economy by reducing the work load of the engine 18.

Each of the electric machines 14 includes a stator and a rotor. The stator includes laminations stacked to form a stator core, which has a hollow center. The stator includes a plurality of coil windings wrapped around the stator core and electrically connected to a voltage source, such as the traction battery 24. A rotor is disposed within the center and is rotatable relative to the stator. The rotor may include permanent magnets configured to interact with a magnetic field created by the windings when energized to produce torque when the electric machine operates as a motor.

The traction battery or battery pack 24 stores energy that can be used by the electric machines 14. The traction battery 24 typically provides a high voltage direct current (DC) output from one or more battery cell arrays, sometimes referred to as battery cell stacks, within the traction battery 24. The battery cell arrays may include one or more battery cells that convert stored chemical energy to electrical energy. The cells may include a housing, a positive electrode (cathode) and a negative electrode (anode). An electrolyte may allow ions to move between the anode and cathode during discharge, and then return during recharge. Terminals may allow current to flow out of the cell for use by the vehicle.

The traction battery 24 may be electrically connected to one or more power electronics modules 26 through one or more contactors (not shown). The one or more contactors isolate the traction battery 24 from other components when opened and connect the traction battery 24 to other components when closed. The power electronics module 26 may be electrically connected to the electric machines 14 and may provide the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to a fully-electric vehicle. In a fully-electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle components. Other high-voltage loads, such as compressors and electric heaters, may be connected directly to the high-voltage supply without the use of a DC/DC converter module 28. In a typical vehicle, the low-voltage systems are electrically connected to an auxiliary battery 30 (e.g., a 12 volt battery).

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36. The external power source 36 is a connection to an electrical outlet. The external power source 36 may be electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (CAN)) or via dedicated electrical conduits.

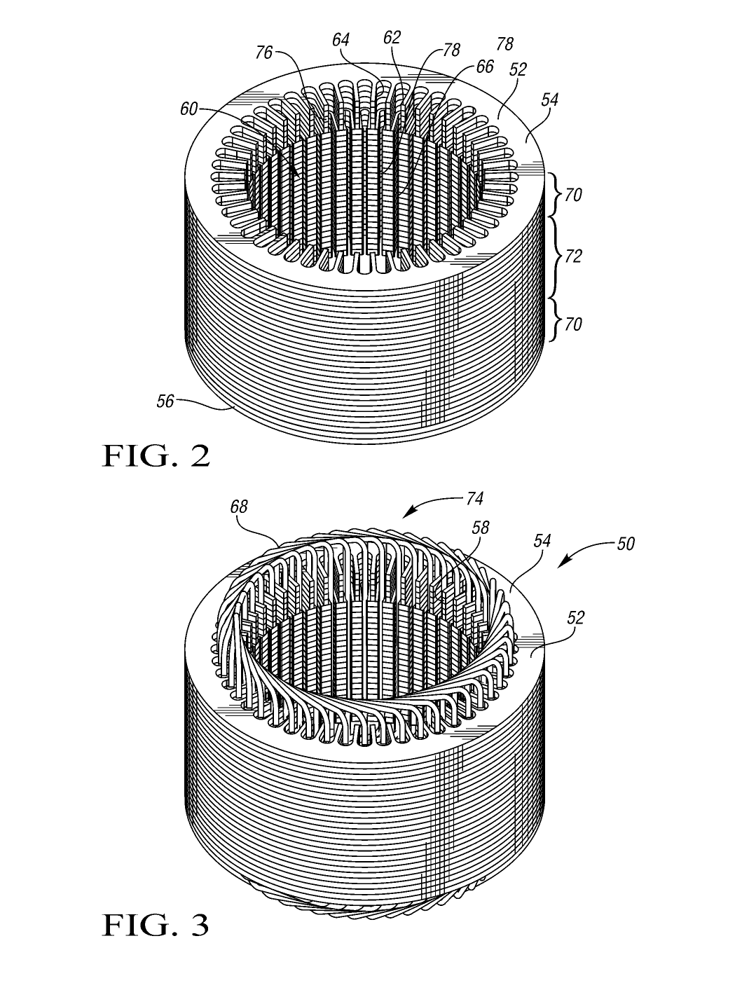

FIGS. 2 through 6 and the related discussion, describe example stators of the electric machine 14. Referring to FIGS. 2 and 3, a stator 50 includes a plurality of laminations 52 stacked to form a stator core 54. Each of the laminations 52 may be doughnut shaped and may define a hollow center. Each lamination 52 includes an outer side 56 and an inner side 58. The outer sides 56 cooperate to define an outer surface of the stator core 54, and the inner sides 58 cooperate to define a cavity 60. The rotor is disposed within the cavity 60 when the electric machine 14 is assembled.

Each lamination 52 includes a plurality of teeth 62 extending radially inward toward the inner side 56. Adjacent teeth 62 cooperate to define slots 64. The teeth 62 and the slots 64 of each lamination 52 are aligned with adjacent laminations to define grooves 66 extending along the stator core 54. A plurality of coil windings 68 are wrapped around the stator core 54 and are disposed within the grooves 66. Portions of the wires generally extend in an axial direction along the grooves 66. At the top and bottom of the stator core, the wires bend to extend circumferentially around the top or bottom of the stator core 54 forming the end windings 74. In many prior art stators, the wires axially extend beyond the first or last lamination before bending to prevent any damage that may be caused by a sharp, 90° bend.

The torque production of an electric machine is at least partially a function of stator core size. Increasing the size of the stator core may increase torque. Vehicles often have packaging restraints that limit the size of the electric machines; thus, it is advantageous to maximize the torque-to-size ratio. The axially extending design of the prior art has a gap between the end windings and the outer-most lamination, which increases the overall length of the stator without increasing the torque. The present disclosure includes a stator core design that reduces the length of the axial extension of the windings beyond the first or last lamination to reduce the gap and increase the torque-to-size ratio.

The stator core 54 may include a middle region (or inner region) 72 sandwiched between two end regions (or outboard regions) 70. The grooves 66 may extend along the entire axial length of the stator core 54 and have portions within each of the regions. For example, the grooves 66 may include end portions 76 and a middle portion 78. The width of the grooves 66 in the end portions 76 may be wider than the width of grooves in the middle portion 78. Having wider grooves near the end windings 74 allows the windings 68 freedom to begin bending within the grooves 66. Because the windings 68 can bend within the grooves, the gap between the end windings 74 and the first or last lamination 52 can be reduced. This allows the stator to be shorted while producing a same torque or allows for additional lamination to increase torque while maintaining a same length.

Each of the regions includes a set of laminations that may be different from the set of laminations of other regions. For example, both of the end regions 70 have identical laminations that are different than the laminations of middle region 72. The teeth 62 of the laminations in the end regions 70 are narrower than the teeth 62 of the laminations in the middle region 72. Thus, the slots 64 defined in the laminations of the end regions 70 are wider than the slots 64 defined in the laminations of the middle region 72. Having wider slots in the end regions 70 increases the width of the grooves 66 near the end windings 74 to provide more room for bending of the wires.

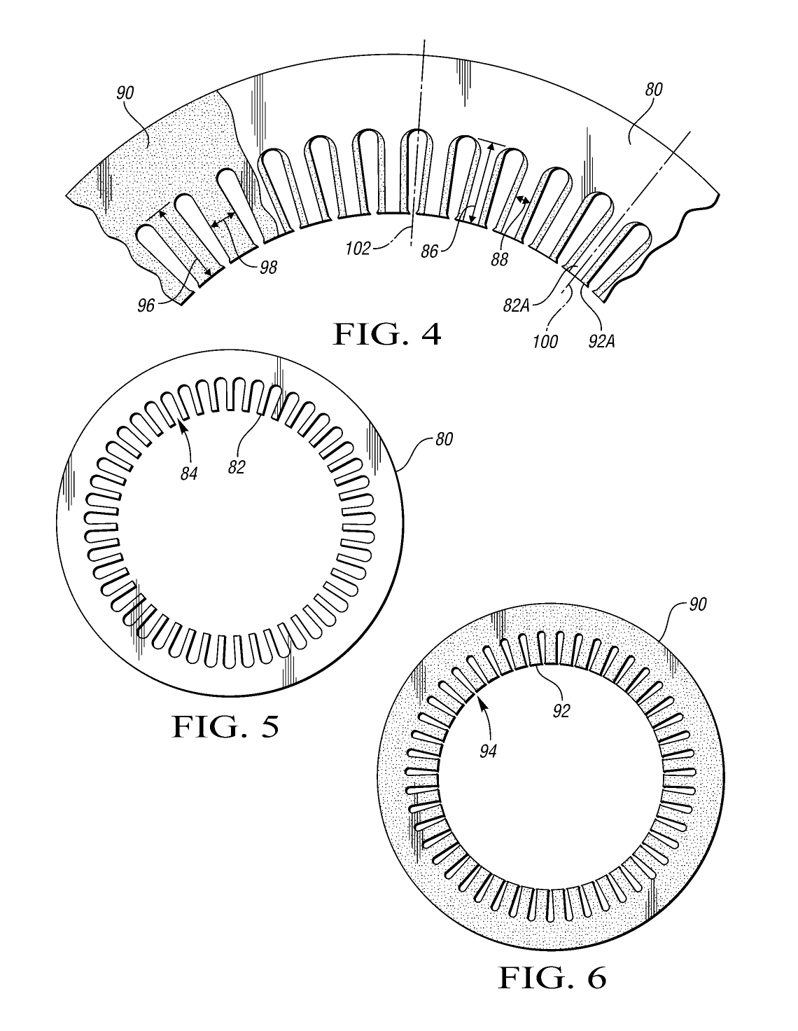

Referring to FIG. 4, at least one of the end regions 70 of the stator core 54 includes a plurality of first laminations 80. Each of the first laminations 80 includes teeth 82 that cooperate to define slots 84 disposed between adjacent teeth. Each of the teeth includes a radial length dimension 86 and a circular width 88. Each of the teeth 82 may be identical. The middle region 72 of the stator core 54 includes a plurality of second laminations 90. Each of the second laminations 90 includes teeth 92 that cooperate to define slots 94 disposed between adjacent teeth. Each of the teeth 92 includes a radial length dimension 96 and a circular width 98. Each of the teeth 92 may be identical.

The teeth 82 have a circular width 88 that is narrower than the circular width 98 of the teeth 92 providing wider slots 84 and thus wider grooves allowing the wires to begin bending earlier than in previous designs. The radial length 86 of the teeth 82 may be the same as the radial length of the teeth 92 providing a uniform depth in the grooves 66. Each of the laminations 80, 90 may be made of a ferrous metal. While illustrated as circular, other geometries are contemplated by the present disclosure. Each of the laminations 80, 90 may include a same number of teeth. The teeth 82 of the first laminations 80 and the teeth 92 of the laminations 90 include a centerline 100. The laminations 80, 90 may be arranged such that the centerlines of the teeth of adjacent laminations are stacked on top of each other. For example, the center line of tooth 92A is aligned with the centerline of tooth 82A. By aligning the centerlines 100 of adjacent teeth, the centerlines 102 of adjacent slots are also aligned creating continuous grooves with straight sidewalls within each of the regions 70, 72 of the stator core 54.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. An electric machine for a vehicle comprising:
a rotor;
a plurality of laminations stacked to form a stator core, each of the laminations having teeth extending towards the rotor and defining slots, wherein the stator core includes first and second sets of laminations, and the teeth of the first set are narrower than the teeth of the second set; and
windings wound in the slots to form coils.

2. The electric machine of claim 1 wherein the first set of laminations defines an end portion of the stator core and the second set of laminations defines a middle portion of the stator core.

3. The electric machine of claim 1 wherein the first and second sets have a same number of teeth.

4. The electric machine of claim 1 wherein the slots have a centerline and the laminations are stacked such that the centerline of each slot is aligned with the centerline of a corresponding slot on an adjacent lamination providing continuous grooves extending along a length of the stator, and wherein the grooves are wider in the first set of laminations than in the second set of laminations.

5. The electric machine of claim 1 wherein the slots in the first set of laminations are wider than the slots in the second set of laminations.

6. The electric machine of claim 1 wherein the teeth on a same lamination are substantially identical.

7. An electric machine comprising:
a rotor;
a stator core including a middle region having first laminations with teeth extending towards the rotor and defining slots, and an end region having second laminations with teeth extending towards the rotor and defining slots, wherein the teeth of the second laminations are narrower than the teeth of the first laminations creating wider slots in the second laminations than in the first laminations; and
windings wound in the slots.

8. The electric machine of claim 7 wherein the first laminations have a same number of teeth and a same number of slots as the second laminations.

9. The electric machine of claim 7 wherein the teeth on the first laminations are identical.

10. The electric machine of claim 9 wherein the teeth on the second laminations are identical.

11. The electric machine of claim 7 wherein each of the slots of the first and second laminations have a centerline and each of the laminations are arranged such that the centerline of each slot is aligned with the centerline of a corresponding slot on an adjacent lamination to provide continuous grooves extending along a length of the stator core, and wherein the portion of the grooves disposed in the end region are wider than the portion disposed in the middle region.

12. The electric machine of claim 7 further comprising another end region having third laminations with teeth extending towards the rotor and defining slots, wherein the teeth of the third laminations are narrower than the teeth of the first laminations creating wider slots in the third laminations than in the first laminations.

13. The electric machine of claim 12 wherein the second laminations are substantially the same as the third laminations.

14. An electric machine stator comprising:
an inboard set of laminations stacked to define a middle portion of the stator, and including first teeth defining slots; and
an outboard set of laminations stacked to define an end portion of the stator, and including second teeth defining slots, wherein the second teeth have a circular width less than the first teeth so as to provide wider slots in the outboard set than in the inboard set.

15. The stator of claim 14 further comprising a plurality of windings wound in each of the slots to form coils.

16. The stator of claim 14 wherein the inboard and outboard sets of laminations have a same number of teeth and a same number of slots.

17. The stator of claim 14 further comprising another outboard set of laminations stacked to define another end portion of the stator, and including third teeth defining slots, wherein the third teeth have a smaller circular width than the first teeth providing wider slots in the another outboard laminations than in the inboard laminations.

18. The stator of claim 17 wherein the second and third teeth have a same circular width.

19. The stator of claim 14 wherein the slots of the inboard set of laminations have a centerline and the slots of the outboard set of laminations have a centerline, wherein the laminations are arranged such the centerline of each slot is aligned with the centerline of a corresponding slot on an adjacent lamination to provide continuous grooves extending along a length of the stator.

20. The stator of claim 17 where the end portions sandwich the middle portion.
